(19) United States
(12) Patent Application Publication
(10) Pub. No.: US 2026/0175683 A1
(43) Pub. Date: Jun. 25, 2026

(54) VEHICLE OPERATION CONTROL SYSTEM

(71) Applicant: TOYOTA JIDOSHA KABUSHIKI KAISHA, Toyota-shi (JP)

(72) Inventors: Toshihiko KOSUGI, Toyota-shi (JP); Keiichi OKA, Seto-shi (JP); Sei KOBAYASHI, Toyota-shi (JP); Masaki HYODO, Okazaki-shi (JP); Taiyo UMEDA, Nisshin-shi (JP)

(21) Appl. No.: 19/399,900

(22) Filed: Nov. 25, 2025

(30) Foreign Application Priority Data
Dec. 24, 2024 (JP) 2024-227996

(51) Int. Cl. B60K 35/10; B60K 35/22; B60K 35/65; B60S 1/08

(52) U.S. Cl. CPC B60K 35/10; B60K 35/22; B60K 35/654; B60S 1/08; B60K 2360/131; B60K 2360/1434; B60K 2360/162

(57) ABSTRACT

A vehicle operation control system, includes: an operation lever that is provided in front of a driver's seat, that is operable by a driver, and that outputs a signal to a predetermined onboard device by being operated; and a display that is provided at a position that is visible to an occupant seated at the driver's seat, wherein: the operation lever is configured to return to a predetermined position when the driver releases a hand from the operation lever; and a status of the onboard device operated by the operation lever is displayed at the display for only a predetermined period of time.

### CROSS-REFERENCE TO RELATED APPLICATION

This application is based on and claims priority under 35 USC 119 from Japanese Patent Application No. 2024-227996 filed on Dec. 24, 2024, the disclosure of which is incorporated by reference herein.

### BACKGROUND

### Technical Field

The present disclosure relates to a vehicle operation control system.

### Related Art

Japanese Patent Application Laid-Open (JP-A) No. 2021-157935 discloses an operation lever for performing operation of a wiper. Specifically, the operation lever can change the sensitivity of the wiper with respect to a rain sensor by tilting the operation lever. Further, the configuration is such that when the driver releases his/her hand from the operation lever, the operation lever returns to the home position.

As in the structure described in Japanese Patent Application Laid-Open (JP-A) No. 2021-157935, by adopting a momentary type operation lever that returns to the home position, the position of the operation lever can always be kept at the same position when not being operated. On the other hand, the current setting value or the like of an onboard device is not known, even by looking at the angle of the operation lever. Further, in a case in which the setting values are constantly displayed, there is a possibility of this feeling bothersome, and there is room for improvement from the perspective of maintaining driver comfort.

### SUMMARY

An object of the present disclosure is to obtain a vehicle operation control system that is capable of maintaining driver comfort in a configuration including a momentary type operation lever.

A vehicle operation control system of a first aspect includes: an operation lever that is provided in front of a driver's seat, that is operable by a driver, and that outputs a signal to a predetermined onboard device by being operated; and a display that is provided at a position that is visible to an occupant seated at the driver's seat, wherein: the operation lever is configured to return to a predetermined position when the driver releases a hand from the operation lever; and a status of the onboard device operated by the operation lever is displayed at the display for only a predetermined period of time.

The vehicle operation control system of the first aspect includes an operation lever that is operable by a driver, and that outputs a signal to a predetermined onboard device by being operated. Further, a display is provided at a position that is visible to an occupant seated at the driver's seat. Note that the operation lever is configured to return to a predetermined position when the driver releases his/her hand from the operation lever. This enables the position of the operation lever to be always kept at the same position when not being operated.

The status of the onboard device operated by the operation lever is displayed at the display for only a predetermined period of time. As a result, the driver can understand the status of the onboard device by looking at the display when operating the operation lever. In addition, the status of the onboard device disappears after a predetermined period of time has elapsed, thereby suppressing a bothersome feeling.

A vehicle operation control system of a second aspect is the vehicle operation control system of the first aspect, wherein: the operation lever is provided at a steering column; and the display includes a monitor that is disposed between a steering operation portion and an instrument panel.

In the vehicle operation control system of the second aspect, the status of the onboard device is displayed at a monitor, which is disposed between the steering operation portion and the instrument panel, by operating the operation lever provided at the steering column. As a result, the status of the onboard device can be understood without significantly moving a line of sight from the operation lever.

A vehicle operation control system of a third aspect is the vehicle operation control system of the second aspect, wherein: the operation lever is configured to actuate a wiper by being operated; and information on a speed of the wiper is displayed at the display.

In the vehicle operation control system of the third aspect, the wiper can be actuated by operating the operation lever. Further, by displaying information on the speed of the wiper at the display, the driver can easily understand the speed of the wiper.

A vehicle operation control system of a fourth aspect is the vehicle operation control system of the third aspect, wherein: the monitor is a touch panel type monitor; and the speed of the wiper is adjustable from the monitor.

In the vehicle operation control system of the fourth aspect, the speed of the wiper can be finely adjusted by touching the monitor after operating the operation lever.

As explained above, the vehicle operation control system according to the present disclosure enables driver comfort to be maintained in a configuration that includes a momentary type operation lever.

### BRIEF DESCRIPTION OF THE DRAWINGS

An exemplary embodiments of the present disclosure will be described in detail based on the following figures, wherein:

FIG. 1 is a diagram illustrating relevant portions of an interior of a vehicle cabin to which a vehicle operation control system according to an exemplary embodiment has been applied;

FIG. 2 is a schematic perspective view schematically illustrating an operation lever in an exemplary embodiment;

FIG. 3 is a block diagram illustrating a hardware configuration of a vehicle operation control system according to an exemplary embodiment;

FIG. 4 is an enlarged diagram of relevant portions which illustrates a display in an exemplary embodiment in an enlarged manner, and illustrates a display example of a non-operating state in which a wiper is not operating; and

FIG. 5 is an enlarged diagram of relevant portions which illustrates a display in an exemplary embodiment in an enlarged manner, and illustrates a display example of an operating state in which a wiper is operating in an AUTO mode.

### DETAILED DESCRIPTION

Explanation follows regarding a vehicle operation control system according to an exemplary embodiment, with reference to the drawings.

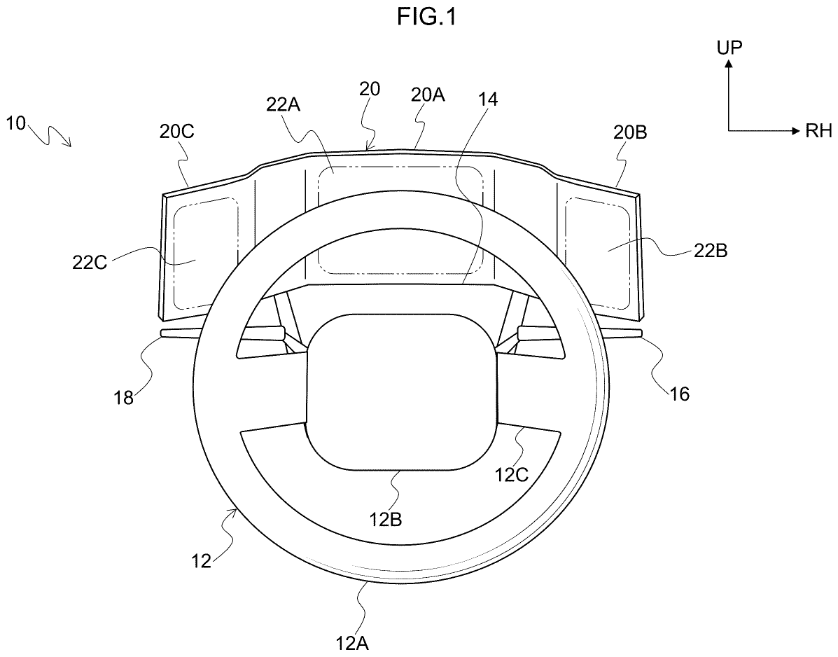

FIG. 1 is a diagram illustrating relevant portions of an interior of a vehicle cabin to which a vehicle operation control system according to an exemplary embodiment has been applied. Note that in the drawings, the arrow FR, the arrow UP, and the arrow RH respectively indicate a vehicle frontward direction, a vehicle upward direction, and a vehicle right direction of a vehicle. In the following explanation, in cases in which front-rear, up-down, and left-right directions are described without any particular notation to the contrary, these indicate front and rear in a vehicle front-rear direction, up and down in a vehicle up-down direction, and left and right in a vehicle left-right direction (width direction), respectively.

As illustrated in FIG. 1, a steering wheel 12, which serves as a steering operation portion that can be gripped by a driver, is provided at a front portion of an interior of a vehicle cabin of a vehicle to which a vehicle operation control system 10 has been applied. The steering wheel 12 is provided with a substantially annular rim portion 12A. Further, a hub portion 12B, which configures a central portion of the steering wheel 12, is provided at an inside circumferential side of the rim portion 12A, and the rim portion 12A and the hub portion 12B are connected by plural spoke portions 12C.

In the present exemplary embodiment, as an example, the rim portion 12A is formed in an annular shape; however, the present disclosure is not limited thereto, and other shapes may be employed. For example, a so-called irregular-shaped steering wheel formed in a substantially U-shape or the like may be employed.

The hub portion 12B is formed in a substantially rectangular shape with rounded corners, and a steering shaft, which is not illustrated in the drawings, is connected to the hub portion 12B. Further, a driver's airbag, which is not illustrated in the drawings, is housed at an interior of the hub portion 12B.

The spoke portions 12C are provided at two positions, namely, between the right side of the rim portion 12A and the hub portion 12B, and between the left side of the rim portion 12A and the hub portion 12B; however, the present disclosure is not limited thereto, and spoke portions may be provided at three or more positions.

A column cover 14 is provided in front of the steering wheel 12. The column cover 14 is a cover made of resin which covers a steering column from the outer side, and which extends in the vehicle front-rear direction. Further, a right-side operation lever 16 and a left-side operation lever 18 are provided at the column cover 14. Details of the right-side operation lever 16 and the left-side operation lever 18 will be described below.

A driver's display 20, which serves as a display, is provided above the column cover 14. The driver's display 20 is positioned between the steering wheel 12 and an instrument panel, and is provided at a position that is visible to an occupant seated at a driver's seat.

The driver's display 20 is formed in a shape that is long in the vehicle width direction, and includes a center monitor portion 20A that is positioned at the center, a right-side monitor portion 20B that is positioned at the right side of the center monitor portion 20A, and a left-side monitor portion 20C that is positioned at the left side of the center monitor portion 20A.

The center monitor portion 20A is positioned in front of the driver's seat, and a center display area 22A, at which predetermined information is displayed, is set. The right-side monitor portion 20B is provided continuously to the center monitor portion 20A at the right side of the center monitor portion 20A, and is positioned at the rear of the right-side operation lever 16. Further, the right-side monitor portion 20B tilts toward a vehicle rear side on progression toward a vehicle right side so as to face the driver. A right-side display area 22B, at which predetermined information is displayed, is set at the right-side monitor portion 20B.

The left-side monitor portion 20C is provided continuously to the center monitor portion 20A at the left side of the center monitor portion 20A, and is positioned at the rear of the left-side operation lever 18. Further, the left-side monitor portion 20C tilts toward the vehicle rear side on progression toward a vehicle left side so as to face the driver. A left-side display area 22C, at which predetermined information is displayed, is set at the left-side monitor portion 20C.

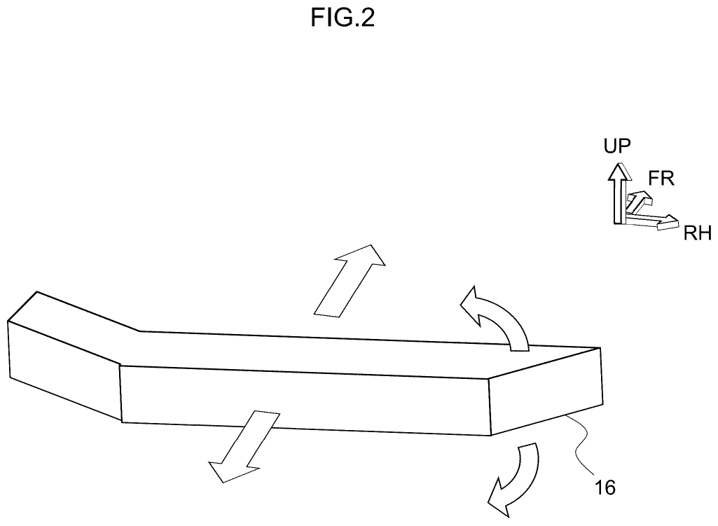

FIG. 2 is a schematic perspective view schematically illustrating the right-side operation lever 16 in the present exemplary embodiment. The right-side operation lever 16 is provided in front of the driver's seat and is configured so as to be operable by the driver, and outputs a signal to a predetermined onboard device when operated. As illustrated in FIG. 2, the right-side operation lever 16 is configured so as to be operable in the vehicle front-rear direction and the vehicle up-down direction with respect to the column cover 14.

Note that in the present exemplary embodiment, as an example, explanation is made regarding a configuration in which a wiper, which serves as an onboard device, can be operated by operating the right-side operation lever 16; however, the present disclosure is not limited thereto, and other onboard devices may be operable by levers. For example, a configuration may be such that a turn signal switch, a headlamp, or the like installed at the vehicle can be operated by the right-side operation lever 16.

When the right-side operation lever 16 of the present exemplary embodiment is moved toward the front side (the rear side), a wiper is actuated only once. Further, when a hand is released from the right-side operation lever 16, the right-side operation lever 16 returns to a predetermined position. When the right-side operation lever 16 is moved toward the rear side (the front side), the wiper is actuated a predetermined number of times, and washer liquid is ejected onto a front windshield. Further, when a hand is released from the right-side operation lever 16, the right-side operation lever 16 returns to the predetermined position.

When the right-side operation lever 16 is moved upward, a mode of the wiper is switched. Similarly, when the right-side operation lever 16 is moved downward, a mode of the wiper is switched. Further, when a hand is released from the right-side operation lever 16, the right-side operation lever 16 returns to the predetermined position. In this manner, the right-side operation lever 16 of the present exemplary embodiment is a momentary type lever, and no other switch such as a dial switch is provided. Therefore, the right-side operation lever 16 is smaller and lighter compared to a lever provided with other switches.

Note that the left-side operation lever 18 is configured with left-right symmetry with the right-side operation lever 16, and is configured so as to be operable in the vehicle front-rear direction and the vehicle up-down direction with respect to the column cover 14, similarly to the right-side operation lever 16. Further, a configuration is such that a turn signal switch and a headlamp, which serve as onboard devices, can be operated by operating the left-side operation lever 18.

For example, when the left-side operation lever 18 is moved toward the front side (the rear side), the headlamp is set to a high beam. Further, when a hand is released from the left-side operation lever 18, the left-side operation lever 18 returns to a predetermined position. Headlight flashing is performed when the left-side operation lever 18 is moved toward the rear side (the front side). Moreover, when a hand is released from the left-side operation lever 18, the left-side operation lever 18 returns to the predetermined position.

When the left-side operation lever 18 is moved upward, a right-side turn signal switch blinks. Further, when the left-side operation lever 18 is moved downward, a left-side turn signal lamp blinks. Furthermore, when a hand is released from the left-side operation lever 18, the left-side operation lever 18 returns to the predetermined position. In this manner, the left-side operation lever 18 of the present exemplary embodiment is a momentary type lever, and no other switch such as a dial switch is provided.

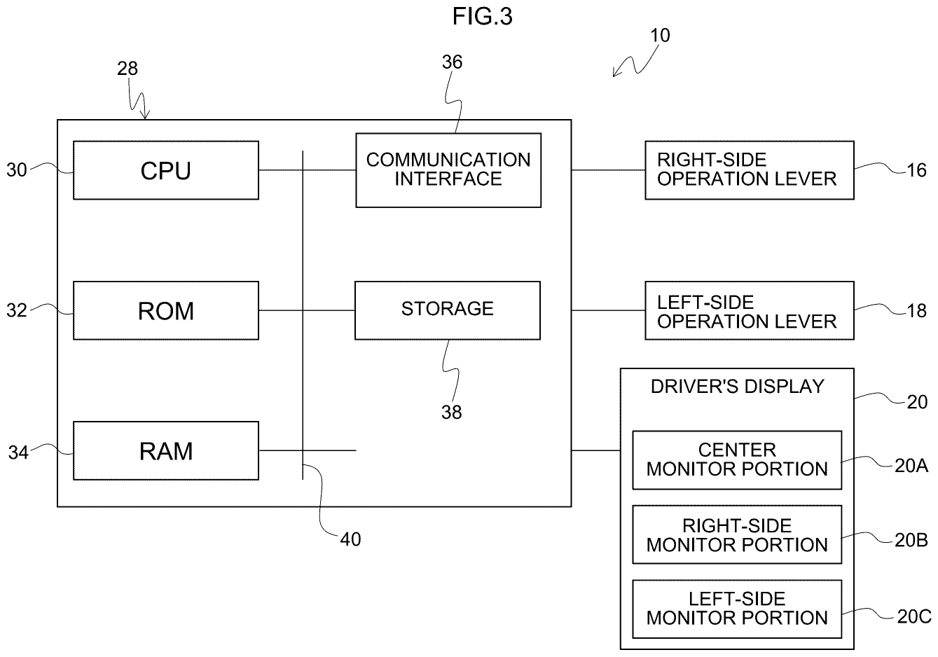

FIG. 3 is a block diagram illustrating a hardware configuration of the vehicle operation control system 10 according to an exemplary embodiment. As illustrated in FIG. 3, the vehicle operation control system 10 of the present exemplary embodiment includes an electronic control unit (ECU) 28.

The ECU 28 includes a central processing unit (CPU; serving as a processor) 30, read only memory (ROM) 32, random access memory (RAM) 34, a communication interface 36, and storage 38. These respective configurations are communicably connected to each other via an internal bus 40.

The CPU 30 is a central processing unit that executes various programs and controls various components. Namely, the CPU 30 reads a program from the ROM 32 or the storage 38, and executes the program using the RAM 34 as a workspace. Further, the CPU 30 controls the respective configurations described above and performs a variety of computation processing in accordance with programs stored in the ROM 32 or the storage 38.

The ROM 32 stores various programs and various data. The RAM 34 serves as a workspace to temporarily store programs and data. The storage 38 is configured by a hard disk drive (HDD) or a solid state drive (SSD), and is a non-transitory storage medium that stores various programs including an operating system, as well as various data.

The communication interface 36 is an interface for communicating with another device such as a terminal. For example, a wired communication standard such as Ethernet (registered trademark) or FDDI, or a wireless communication standard such as 4G, 5G, or Wi-Fi (registered trademark) is used for the aforementioned communication.

The ECU 28 is electrically connected to the right-side operation lever 16, the left-side operation lever 18, and the driver's display 20. Further, the ECU 28 is electrically connected to onboard devices, which are not illustrated in the drawings, and receives a predetermined signal accompanying an operation when the driver operates the right-side operation lever 16 or the left-side operation lever 18, and transmits a signal to the onboard devices in accordance with the received signal.

Information to be displayed at the center monitor portion 20A, the right-side monitor portion 20B, and the left-side monitor portion 20C of the driver's display 20 is switched in accordance with a signal from the ECU 28.

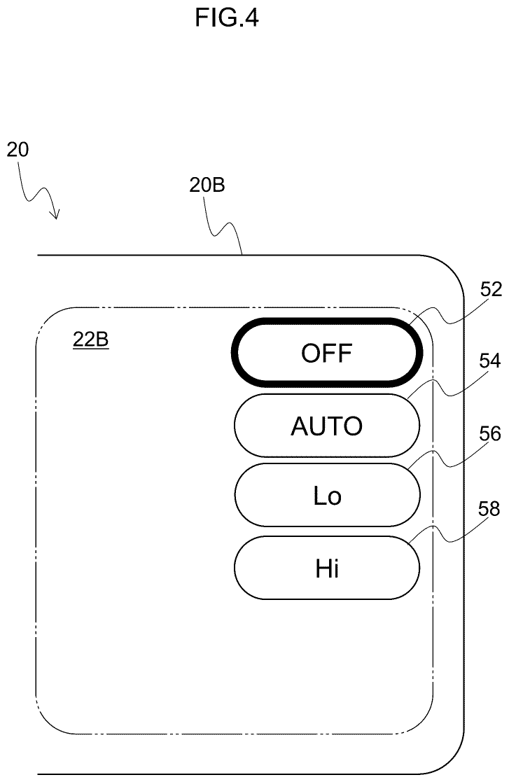

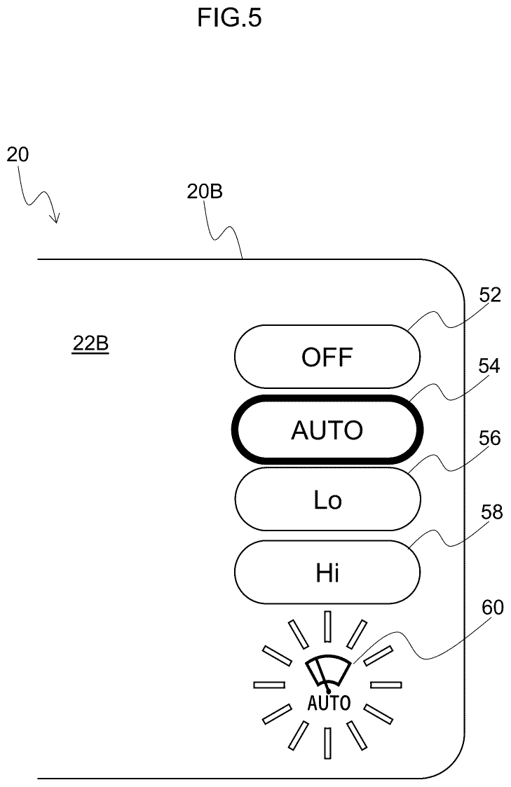

FIG. 4 is an enlarged diagram of relevant portions which illustrates the right-side monitor portion 20B in an exemplary embodiment in an enlarged manner, and illustrates a display example of a non-operating state in which a wiper is not operating. Further, FIG. 5 is an enlarged diagram of relevant portions which illustrates the right-side monitor portion 20B in an exemplary embodiment in an enlarged manner, and illustrates a display example of an operating state in which a wiper is operated in an AUTO mode.

As illustrated in FIG. 4, in a non-operating state in which the wiper is not operating, an icon 52, indicated as “OFF”, an icon 54, indicated as “AUTO”, an icon 56, indicated as “Lo”, and an icon 58, indicated as “Hi”, are displayed in order from the top in the right-side display area 22B of the right-side monitor portion 20B of the driver's display 20.

In a non-operating state in which the wiper is not operating, the frame of the icon 52, “OFF”, is thicker than the other icons, indicating that the wiper is OFF. Namely, the status of the wiper is displayed at the right-side monitor portion 20B.

In the state illustrated in FIG. 4, when the right-side operation lever 16 is moved downward, a mode of the wiper is switched. Specifically, the wiper is switched to an AUTO mode. In the AUTO mode, the speed of the wiper is changed based on rain amount information detected by a rain sensor, which is not illustrated in the drawings, installed at the vehicle.

When this occurs, the display of the right-side display area 22B at the right-side monitor portion 20B transitions to the state illustrated in FIG. 5. Namely, as illustrated in FIG. 5, the frame of the icon 54, “AUTO”, is displayed thicker than the other icons, and the frame of the icon 52, “OFF”, has the same thickness as the other icons.

Further, an icon 60 is displayed at the lower right of the right-side display area 22B. The icon 60 is an icon indicating that the wiper is operating in the AUTO mode.

Note that in the present exemplary embodiment, the icon 52, the icon 54, the icon 56, and the icon 58 are displayed for only a predetermined period of time after a mode of the wiper has been switched. Further, the icon 60 is continuously displayed while the wiper is operating in the AUTO mode.

In the state illustrated in FIG. 5, when the right-side operation lever 16 is moved downward, the mode of the wiper is switched. Specifically, the wiper is switched to a Lo mode. In the Lo mode, the wiper is operated at a constant speed, regardless of the rain amount detected by the rain sensor.

When this occurs, in the display of the right-side display area 22B at the right-side monitor portion 20B, the frame of the icon 56, “Lo”, is displayed thicker than the other icons, and the frame of the icon 54, “AUTO”, has the same thickness as the other icons. Further, the icon 52, the icon 54, the icon 56, and the icon 58 are displayed for only a predetermined period of time. Moreover, the icon 60 is turned off.

When the right-side operation lever 16 is moved downward in a state in which the wiper is operating in the Lo mode, the mode of the wiper is switched. Specifically, the wiper is switched to a Hi mode. In the Hi mode, the wiper is operated at a constant speed, regardless of the rain amount detected by the rain sensor. Further, the speed of the wiper is faster than in the Lo mode.

When this occurs, in the display of the right-side display area 22B, the frame of the icon 58, “Hi”, is displayed thicker than the other icons, and the frame of the icon 56, “Lo”, is the same thickness as the other icons. Further, the icon 52, the icon 54, the icon 56, and the icon 58 are displayed for only a predetermined period of time. In this manner, information regarding the speed of the wiper is displayed for only a predetermined period of time at the right-side monitor portion 20B when the right-side operation lever 16 is operated.

The right-side monitor portion 20B of the present exemplary embodiment is a touch panel type monitor, and includes, for example, sensors such as electrostatic sensors. Further, as illustrated in FIG. 5, a configuration is such that the mode (speed) of the wiper can be changed when the driver touches another icon when the icon 52, the icon 54, the icon 56, and the icon 58 are displayed. For example, the wiper can be operated in the Lo mode by the driver touching the icon 56, “Lo”, from the state illustrated in FIG. 5.

### Operation

Explanation follows regarding operation of the vehicle operation control system according to the present exemplary embodiment.

As illustrated in FIG. 1, the vehicle operation control system 10 according to the present exemplary embodiment includes the right-side operation lever 16 and the left-side operation lever 18 that are operable by the driver, and when operated, the right-side operation lever 16 outputs a signal to a wiper serving as a predetermined onboard device. Further, the driver's display 20 is provided at a position that is visible to an occupant seated at the driver's seat. Note that the right-side operation lever 16 and the left-side operation lever 18 are configured so as to return to a predetermined position when the driver releases his/her hand therefrom. This enables the positions of the right-side operation lever 16 and the left-side operation lever 18 to be always kept at the same positions when not being operated.

As illustrated in FIG. 4 and FIG. 5, the status of the wiper operated by the right-side operation lever 16 is displayed for only a predetermined period of time at the right-side display area 22B of the right-side monitor portion 20B of the driver's display 20. Therefore, the driver can understand the status of the wiper by looking at the right-side monitor portion 20B when operating the right-side operation lever 16. In addition, the status of the onboard device disappears after a predetermined period of time has elapsed, thereby suppressing a bothersome feeling. Namely, in a configuration including a momentary type operation lever, driver comfort can be maintained.

As illustrated in FIG. 1, in the present exemplary embodiment, by operating the right-side operation lever 16 provided at the column cover 14, the status of the wiper is displayed at the driver's display 20 disposed between the steering wheel 12 and the instrument panel. This enables the status of the wiper to be understood without significantly moving a line of sight from the right-side operation lever 16. In particular, in the present exemplary embodiment, the right-side monitor portion 20B is disposed at the rear of the right-side operation lever 16, such that operation of the right-side operation lever 16 and a status check of the wiper can be performed almost without moving a line of sight.

In the present exemplary embodiment, information regarding the speed of the wiper is displayed at the right-side display area 22B of the right-side monitor portion 20B, thereby enabling the driver to easily understand the speed of the wiper.

Further, in the present exemplary embodiment, the speed of the wiper can be finely adjusted by touching the right-side monitor portion 20B after the driver has operated the right-side operation lever 16.

Although explanation has been given regarding the vehicle operation control system according to the present disclosure, obviously various embodiments may be implemented within a range not departing from the gist of the present disclosure. For example, in the present exemplary embodiment, although a configuration is such that the wiper is actuated by operating the right-side operation lever 16, and the turn signal switch, the headlamp, and the like are actuated by operating the left-side operation lever 18, the present disclosure is not limited thereto, and the configuration may be reversed.

Further, in the present exemplary embodiment, although a configuration is such that the status of the wiper is displayed at the right-side display area 22B of the right-side monitor portion 20B, the present disclosure is not limited thereto, and the status of the wiper may be displayed at another display area. For example, the status of the wiper may be displayed at the center display area 22A of the center monitor portion 20A. Alternatively, the status of the wiper may be displayed at a display area configured by a center display provided at the instrument panel or the like, or by a head-up display that is projected onto the windshield.

Further, in the present exemplary embodiment, although the right-side monitor portion 20B is of a touch panel type, the present disclosure is not limited thereto. For example, a press-down type switch may be provided at the outer edge of the right-side monitor portion 20B.

With regard to the above-described exemplary embodiment, the following additional notes are disclosed.

### Additional Note 1

A vehicle operation control system includes: an operation lever that is provided in front of a driver's seat, that is operable by a driver, and that outputs a signal to a predetermined onboard device by being operated; and a display that is provided at a position that is visible to an occupant seated at the driver's seat, wherein: the operation lever is configured to return to a predetermined position when the driver releases a hand from the operation lever; and a status of the onboard device operated by the operation lever is displayed at the display for only a predetermined period of time.

### Additional Note 2

The vehicle operation control system according to Additional Note 1, wherein: the operation lever is provided at a steering column; and the display includes a monitor that is disposed between a steering operation portion and an instrument panel.

### Additional Note 3

The vehicle operation control system according to Additional Note 1 or Additional Note 2, wherein: the operation lever is configured to actuate a wiper by being operated; and information on a speed of the wiper is displayed at the display.

### Additional Note 4

The vehicle operation control system according to Additional Note 3, wherein: the monitor is a touch panel type monitor; and the speed of the wiper is adjustable from the monitor.

What is claimed is:

1. A vehicle operation control system, comprising:
an operation lever that is provided in front of a driver's seat, that is operable by a driver, and that outputs a signal to a predetermined onboard device by being operated; and
a display that is provided at a position that is visible to an occupant seated at the driver's seat, wherein:
the operation lever is configured to return to a predetermined position when the driver releases a hand from the operation lever; and
a status of the onboard device operated by the operation lever is displayed at the display for only a predetermined period of time.

2. The vehicle operation control system according to claim 1, wherein:
the operation lever is provided at a steering column; and
the display includes a monitor that is disposed between a steering operation portion and an instrument panel.

3. The vehicle operation control system according to claim 2, wherein:
the operation lever is configured to actuate a wiper by being operated; and
information on a speed of the wiper is displayed at the display.

4. The vehicle operation control system according to claim 3, wherein:
the monitor is a touch panel type monitor; and
the speed of the wiper is adjustable from the monitor.
